(19) United States
(12) Patent Application Publication
(10) Pub. No.: US 2006/0005219 A1
(43) Pub. Date: Jan. 5, 2006

(54) Standby television warning system

(76) Inventor: Garry Owens, Lebanon, TN (US)

Correspondence Address: PITTS AND BRITTIAN P C, P O BOX 51295, KNOXVILLE, TN, 37950-1295, US

(21) Appl. No.: 10/884,211

(22) Filed: Jul. 2, 2004

(51) Int. Cl. H04N 7/025; G08B 1/08; H04B 1/16; H04N 11/00

(52) U.S. Cl. 725/33; 340/539.1; 348/461; 455/228

(57) ABSTRACT

An apparatus for an emergency alert system integrated in a television receiver. A decoder monitors the tuner output for a coded signal indicating that an emergency message is being broadcast. The decoder turns on the television receiver, if not already on, and adjusts the volume to deliver the emergency message. In one embodiment, the decoder switches a standby power supply from a standby mode to a full power mode, thereby enabling the television receiver to present the emergency message. In one embodiment, after a selected period, the television receiver is returned to its previous state. In another embodiment, after receiving an end of message code, the television receiver is returned to its previous state.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to an emergency alert system. More particularly, this invention pertains to television receivers adapted to receive emergency alerts when the television is in a standby or off condition.

2. Description of the Related Art

The Emergency Alert System (EAS), which was preceded by the Emergency Broadcast System, is a government service that provides timely and critical warning to customers of public broadcast media. The EAS was established by the FCC in 1994. In the event of an imminent emergency condition, such as a tornado or other severe weather or a fire, a government authority sends a general public warning message over the Emergency Alert System. The dissemination of these warning messages is crucial to the proper operation of the Emergency Alert System.

One system for processing such warning messages is disclosed in U.S. Pat. No. 6,452,492, titled “Emergency alert system,” issued to Drury, on Sep. 17, 2002. Drury discloses an alert system that operates over a cable system network, such as the convention cable television system. The alert system includes an alert system receiver connected to the cable system. The alert system receiver shares the same incoming cable system signals as the television receiver connected to the cable system; however, the alert system receiver is independent of the television receiver. The alert system receiver monitors for alert signals and provides indication when an alert message is received.

Another system is disclosed in U.S. Pat. No. 6,498,627, titled “Use of wideband DTV overlay signals for brevity signaling and public safety,” issued to Hershey, et al., on Dec. 24, 2002. Hershey discloses a brevity signaling module for a digital television receiver. The module enables reception of emergency broadcast messages transmitted over a wideband overlay signal used to reduce the multipath problem with digital high definition television (HDTV) receivers. To enable reception of an emergency broadcast message, the broadcaster must shift the frequency of the wideband overlay signal. The brevity signaling module detects the overlay signal frequency shift and processes the message.

Another system is disclosed in U.S. Pat. No. 5,029,290, titled “Emergency alert system,” issued to Parsons, et al., on Jul. 2, 1991. Parsons discloses an alarm system that operates over the telecommunications network to alert selected individuals of an emergency. The alarm system includes a main unit located at the central office of the telecommunications company and alarm units installed in parallel with the subscriber's telephone. Authorized authorities telephone the main unit to invoke the alert system. Codes are entered by the authority to indicate which zones are to be alerted of the emergency. Telecommunication subscribers in that zone are then automatically alerted regardless of whether the subscriber's phone is off-hook or busy prior to alarm activation.

### BRIEF SUMMARY OF THE INVENTION

According to one embodiment of the present invention, an emergency alert system is provided. The emergency alert system is integrated in a television receiver and continuously monitors broadcast signals for the transmission of a warning message. The alert system uses features of the standby power supplies in modern television receivers to monitor the broadcast signals when the television receiver is not in use.

In one embodiment, the alert system is adapted to integrate with existing television receivers by monitoring the output of the existing tuner. The system, when it detects an emergency broadcast signal, turns on the television and allows the message to be delivered.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment of standby television warning system;

FIG. 2 is a block diagram of one embodiment of the system; and

FIG. 3 is a flow diagram of one embodiment of the steps for processing warnings.

### DETAILED DESCRIPTION OF THE INVENTION

An apparatus for an emergency alert system 10 is disclosed. The emergency alert system 10 receives an advisory report sent over the transmission frequencies of the television broadcasting system. The advisory report includes information regarding weather conditions such as tornados and storms, natural disasters such as earthquakes and avalanches, chemical spills, and homeland security issues such as bomb threats and terrorist attacks. The emergency alert system 10 is for alerting individuals watching their television and for alerting individuals who do not have their televisions in the on position, such as those who are sleeping, when an urgent situation occurs. More specifically, the emergency alert system 10 activates a dormant television such that an individual who is not watching the television or who is sleeping is alerted to the advisory report.

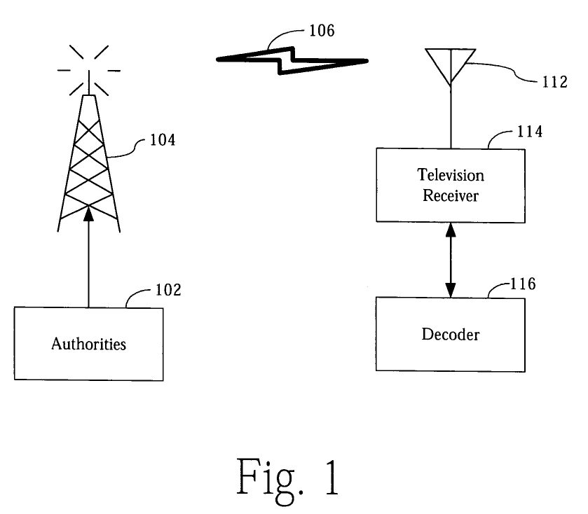

FIG. 1 illustrates an emergency alert system 10. The authorities 102 control the transmission of emergency warning messages 106 through a transmitting system 104. The emergency warning messages 106 are received by an antenna 112 connected to a television receiver 114. The television receiver 114 is connected to a decoder 116 that monitors the received signals for any emergency warning messages 106 and then controls the television receiver 114 to present the emergency warning message 106.

In one embodiment, the authorities 102 are local. After the local authorities 102 determine all pertinent information regarding a particular urgent situation, the information is incorporated into an emergency warning message 106 sent to a local area. In another embodiment, the authorities 102 are not local, but are responsible for a large constituency, such as national or multi-state. In this embodiment, the authorities 102 determine all pertinent information regarding a particular urgent situation, including information as to the geographic areas in which the warning message 106 is applicable. In one embodiment, the geographic areas are based on Postal Service ZIP codes. This information is incorporated into a emergency warning message 106, which is then transmitted by the transmitting system 104 nationwide or over a wide area extending beyond a local area. In another embodiment, the emergency warning message 106 originates from the Emergency Alert System (EAS), which includes location specific information in an EAS header code. In these embodiments, the television receiver 114 and/or decoder 116 includes circuitry and/or logic to determine whether a received emergency warning message 106 is applicable to the area in which the television receiver 114 is located.

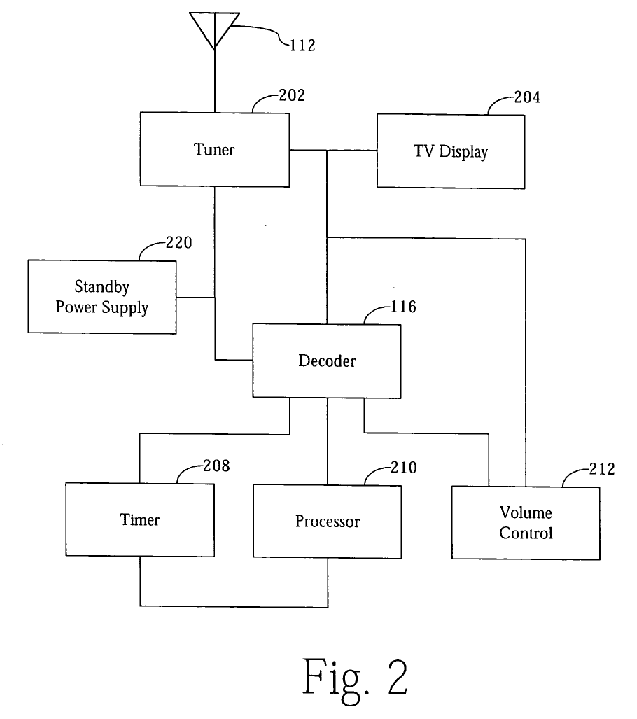

FIG. 2 illustrates one embodiment of the emergency alert system 10. The television tuner 202 receives broadcast signals via an antenna 112. In another embodiment, the tuner 202 receives broadcast signals via a cable, such as used in a cable network. The tuner 202 provides signals to the television display 204, which presents the video portion of the broadcast signal, to the volume control 212, which presents the audio portion of the broadcast signal, and to the decoder 206, which monitors for emergency warning messages 106. In one embodiment, the television display 204 presents both the video and the audio portions of the broadcast content.

The emergency alert system 10 includes a standby power supply 220, which provides power to the other circuits in the emergency alert system 10, such as the tuner 202 and the decoder 206. In one embodiment, the standby power supply 220 has two operational modes. The first, or full power, mode is with the power supply 220 supplying full power to all equipment and circuits. The second, or standby, mode is with the power supply 220 isolating certain circuits, but providing power to a few selected circuits. In this second mode, the television receiver 114 is considered to be off, or deenergized; however, selected circuits remain energized for specific purposes, for example, a remote control receiver for turning on the television receiver 114 via a remote control unit. In the illustrated embodiment, the power supply 220 provides power in the standby mode to the tuner 202 and to the decoder 206. In other embodiments, the power supply 220 provides power in the standby mode to other selected circuits, for example, the remote control receiver.

The decoder 206 communicates with a processor 210 and with a timer 208, which communicate with each other 208, 210. The decoder 206 communicates with the standby power supply 220 in order to switch the power supply 220 from standby mode into full power mode. The decoder 206 also communicates with the volume control 212 to ensure that the volume is set at an appropriate level to reproduce the emergency warning message 106. The ability to set the volume control 212 provides for the situation where the user has turned the volume off or down to an inaudible level.

In the illustrated embodiment, the emergency alert system 10 operates in the following manner: the tuner 202 is continually powered by the power supply 220, or at least sufficient circuits are powered such that the tuner 202 can receive and pass on a broadcast signal to the decoder 206. The tuner 202 is set to continually monitor a broadcast station and that signal is routed to the decoder 206. The decoder 206 continually monitors the signal from the tuner 202 for a code that indicates that an emergency warning message 106 is being broadcast. In one embodiment, the emergency warning message 106 contains a coded preamble consisting of a series of frequency burst pulses. When the decoder 206 detects a coded preamble indicating that an emergency warning message 106 is directed to the area in which the emergency alert system 10 is located, the decoder 206 sends a signal to the standby power supply 206 switching the power supply 206 to the full power mode, if it is not already operating in that mode. The decoder 206 also sends a signal to the volume control 212 to adjust the volume to a preset level. The decoder 206 communicates with the processor 210 and a timer 208 for controlling the television receiver 114, including the television display 204, to present the emergency warning message 106. The timer 208 tracks the time starting with the receipt of the emergency warning message 106 and provides a stop signal to the processor 210 after a specified time has elapsed, thereby ensuring that the television receiver 114 is restored to the state it was in before receiving the emergency warning message 106. In another embodiment, the emergency alert system 10 does not include a timer 208, but instead the decoder 116 monitors for an end of message code sent with the EAS message 106. After receipt of the end of message code, the television receiver 114 is restored to the state it was in before receiving the emergency warning message 106.

In another embodiment, the decoder 206, upon detection of a valid emergency warning message 106, sends a signal to the processor 210, which runs a software routine that switches the power supply 220 to full power mode and adjusts the volume control 212 to a preselected level. The processor 210 then controls the television receiver 114 to play the emergency warning message 106. After the emergency warning message 106 is played, the processor 210 restores the television receiver 114 to its pre-warning state, whether it be standby or receiving some other programming.

In one embodiment, the emergency alert system 10 is responsive to a geographic area. Many of the urgent situations requiring an emergency warning message 106 are location specific. For example, a snow storm or an earthquake affects only a portion of the United States in terms of urgency. Consequently, in this embodiment, the emergency alert system 10 informs only the individuals living in a region or area affected by the corresponding urgent situation. In one embodiment, the emergency alert system 10 is responsive to emergency warning messages 106 directed to individuals with a selected United States Postal Service ZIP codes. Those skilled in the art will recognize that area or geographic divisions other than ZIP codes may be used without interfering with the scope or spirit of the present invention.

In another embodiment, the emergency alert system 10 is responsive to a geographic area as defined by the existing Emergency Alert System (EAS). The EAS uses a four part message for an emergency activation of the EAS. The four parts are: the preamble and EAS header codes, the audio attention signal, the message, and the preamble and EAS end of message codes. The EAS header codes include a location code that indicates the geographic area affected by the EAS alert. Currently, there are 31 location codes in an EAS alert. The location code uses the Federal Information Processing Standard (FIPS) numbers as described by the U.S. Department of Commerce in National Institute of Standards and Technology publication FIPS PUB 6-4. Each state is assigned a number. Each county and some cities are assigned a number. One number is used to indicate an entire State or Territory. Other numbers indicate county subdivisions when the alert applies to a small geographic area.

In one embodiment, the decoder 116 determines the area for which the received emergency warning message 106 is applicable and compares it with the stored area in which the television receiver 114 is located. In another embodiment, the decoder 116 passes the area information to the processor 210 and the processor 210 compares it with stored data corresponding with the area in which the television receiver 114 is located. In one embodiment, the timer 208 is responsive to a selected time to stop the playback of the emergency warning message 106. In other embodiments, either the decoder 116 or the processor 210 monitors the emergency warning message 106 for the end of message code, after which being received, the television receiver 114 is restored to its previous state.

In still another embodiment, the emergency alert system 10 is responsive to a geographic area as defined by the NOAA Weather Radio Specific Area Message Encoding (NWR-SAME) Codes. In this embodiment, the emergency warning message 106 is originated by the National Weather Service.

The embodiment illustrated in FIG. 2 also is adapted for integration in an existing television receiver 114. In the embodiment in which the emergency alert system 10 is integrated in an existing television receiver 114, the tuner 202, the television display 204, the standby power supply 220, the processor 210, and the volume control 212 exist in the television receiver 114 and the decoder 116 is wired into the circuit to communicate with these existing devices 202, 204, 220, 210, 212. In another embodiment, a timer 208 is also added to the circuit, along with the decoder 116. In these embodiments, the emergency alert system 10 operates in the same manner as described above.

As used herein, the processor 210 should be broadly construed to mean any computer or component thereof that executes software. The processor 210 includes a memory medium that stores software, a processing unit that executes the software, and input/output (I/O) units for communicating with external devices. Those skilled in the art will recognize that the memory medium associated with the processor 210 can be either internal or external to the processing unit of the processor without departing from the scope and spirit of the present invention.

In one embodiment the processor 210 is a general purpose computer, in another embodiment, it is a specialized device for implementing the functions of the invention. Those skilled in the art will recognize that the processor 210 includes an input component, an output component, a storage component, and a processing component. The input and output components receives input and sends output, respectively, from external devices, such as the tuner 202, the television display 204, the standby power supply 220, and the volume control 212. The storage component stores data and program code. In one embodiment, the storage component includes random access memory. In another embodiment, the storage component includes non-volatile memory, such as EPROMs, floppy disks, hard disks, and writeable optical disks. The processing component executes the instructions included in the software and routines.

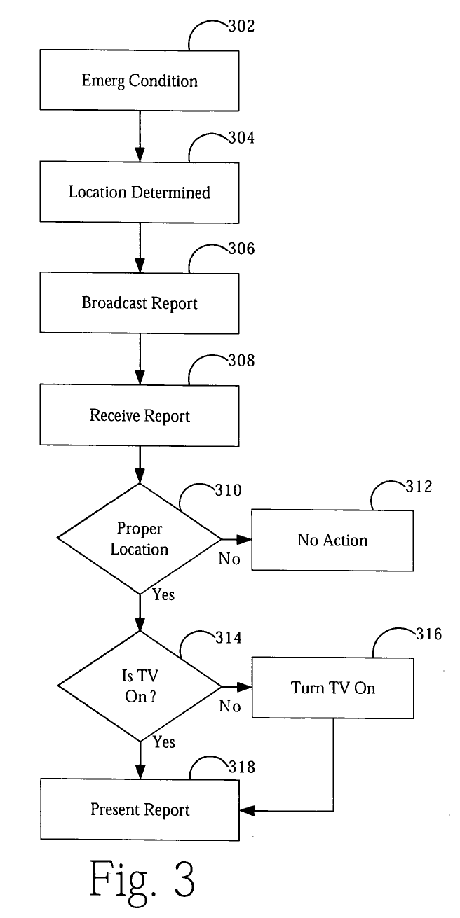

FIG. 3 illustrates a flow diagram of one embodiment of the emergency alert system 10. The first step is the determination that an emergency condition exists 302. Then, the location to which the emergency condition applies is determined 304. After the location is determined 304, the report, or emergency warning message 106, is broadcast 306. In one embodiment, the first three steps 302, 304, 304 are performed by the authorities 102 through the transmission system 104. In another embodiment, these steps 302, 304, 304 are performed as part of the Emergency Broadcast System operation.

After the emergency warning message 106 is broadcast 306, the message is received 308. In one embodiment, the message 106 is received by the television receiver 114. The location is evaluated 310 and no action 312 is taken if the location specified in the message 106 is determined to be different than the location of the television receiver 114. If the location of the television receiver 114 is within the specified location, the status of the television is evaluated 314. If the television is not on 314, then the television is turned on 316. Turning on the television, in one embodiment, includes switching the standby power supply 220 to the full power mode and setting the volume control 212 to a selected volume level. The emergency warning message 106 is then presented 318, which includes displaying any video portion of the message 106 and any audio portion of the message 106. If the television is on 314, then the emergency warning message 106 is presented 318. In various embodiments, the evaluation that the location is proper 310 and the evaluation of whether the television is turned on 314 is performed by the decoder 116 and/or the processor 210.

In one embodiment, some of the functions identified in FIG. 3 are performed by one or more software routines run by the processor 210. In another embodiment, one or more of the functions identified are performed by hardware and the remainder of the functions are performed by one or more software routines run by the processor 210. In still another embodiment, the functions are implemented with hardware, with the processor 210 providing routing and control of the entire integrated system 10. The processor 210 executes software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, a routine refers to code that performs a specified function, whereas software is a more general term that may include more than one routine or perform more than one function.

The emergency alert system 10 includes various functions. The function of determining if an emergency warning message 106 is applicable to a location of the emergency alert system 10, in one embodiment, is implemented by the decoder 116 determining the location code embedded in an emergency warning message 106 and determining if the embedded code corresponds with a location code stored in the decoder 116. In another embodiment, this function is implemented by the processor 210 comparing the location code embedded in the emergency warning message 106 with a location code stored in the processor 210.

The function of switching the power supply 220 to full power mode from a standby mode, in one embodiment, is implemented by the decoder 116 determining that an emergency warning message 106 is being received and sending a signal to the power supply 220. In another embodiment, this function is implemented by the decoder 116 sending a signal to the processor 210, which controls the power supply 220. In still another embodiment, this function is implemented by the processor 210 controlling the power supply 220 after the decoder 116 detects an emergency warning message 106.

The function of presenting an emergency warning message 106, in one embodiment, is implemented by the television receiver 114, and in another embodiment, by the television display 204. In still another embodiment, this function is performed by the television display 204, which presents the video portion of the message 106, and the volume control 212, which presents the audio portion of the message 106. In still another embodiment, the volume control 212 is set to a preselected volume level before presenting the audio portion of the message 106.

The function of activating a message presenting system or a television receiver, in one embodiment, is implemented by the decoder 116 determining the presence of an emergency warning message 106 in the broadcast signal received by the tuner 202 and then causing the power supply 220 to switch to a full power mode, which causes the television receiver 114 to be in a condition to present the message 106. In another embodiment, this function is implemented by the decoder 116 determining the presence of an emergency warning message 106 and communicating this information to the processor 210, which causes the power supply 220 to switch to a full power mode. In another embodiment, this function also includes setting the volume control 212 to a preselected volume level before presenting the audio portion of the message 106.

The function of receiving a plurality of television broadcasts, in one embodiment, is implemented by the television receiver 114. In another embodiment, this function is implemented by the tuner 202. The tuner 202, in one embodiment, is connected to an antenna 112 receptive to broadcast signals sent over the airwaves. In another embodiment, the tuner 202 is connected to a cable network system that provides television signals.

The function of decoding said plurality of television broadcasts to determine whether an emergency warning message 106 is present, in one embodiment, is implemented by the decoder 116 determining the presence of an emergency warning message 106 in the broadcast signal received by the tuner 202. In various embodiments, the decoder 116 is configured to detect the EAS header code or the audio attention signal accompanying the Emergency Alert System message sent over television broadcast frequencies. In one embodiment, the decoder 116 extracts the coded information contained within the EAS header code. In various embodiments, the coded information includes one or more of the location information, the event code, the valid time period of the event, and the source of the message 106.

The function of deactivating the message presenting system, in one embodiment, is implemented by the timer 208, which starts a timing cycle upon detection of an emergency warning message 106 and ends the timing cycle after a preselected time. The end of the timing cycle, in one embodiment, causes the processor 210 to restore the power supply 220 to its previous state, and in another embodiment, directly causes the power supply 220 to return to its previous state. In still other embodiments, either the decoder 116 or the processor 210 detects an end of message code signaling the end of the emergency warning message 106 by the Emergency Alert System. Detection of this end of message code results in either the decoder 116 or the processor 210 returning the power supply 220 to its previous state, thereby deactivating the message presenting system.

From the foregoing description, it will be recognized by those skilled in the art that a emergency alert system 10 has been provided. The emergency alert system 10 is integrated with a television receiver 114 and is responsive to emergency alerts transmitted by an authority 102. The emergency alert system 10 includes a decoder 116 that is responsive to a preamble included in an emergency warning message 106. In one embodiment, the preamble includes location information.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus, and illustrative examples shown and described. Accordingly, departures may be made from such details without departing from the spirit or scope of applicant's general inventive concept.

Having thus described the aforementioned invention, we claim:

1. An apparatus for receiving an emergency warning message, said apparatus comprising:
a power supply operable in at least a full power mode and a standby mode, said power supply providing power to a television receiver;
a tuner in said television receiver for receiving a plurality of television broadcasts, said tuner being operable with said power supply in said standby mode;
a decoder receiving a broadcast signal from said tuner, said decoder being operable with said power supply in said standby mode, said decoder monitoring for an emergency warning message contained in said broadcast signal, said decoder causing said power supply to switch to said full power mode upon receipt of said emergency warning message thereby causing said television receiver to be fully operable, said decoder generating a volume control signal upon receipt of said emergency warning message;
a volume control responsive to said volume control signal whereby said volume control is set at a selected volume level upon receipt of said volume control signal; and
a television display presenting said emergency warning message, wherein said power supply, said tuner, said decoder, said volume control, and said television display are integrated into a single unit.

2. The apparatus of claim 1 further including a processor executing a process including determining if said emergency warning message is applicable to a location of said apparatus.

3. The apparatus of claim 1 further including a processor executing a process including switching said power supply to full power mode from said standby mode.

4. The apparatus of claim 1 further including a timer responsive to receipt of said emergency warning message, said timer returning said power supply to said standby mode after a selected time.

5. The apparatus of claim 1 wherein said decoder is responsive to an end of message code, said decoder returning said power supply to said standby mode after receiving said end of message code.

6. An apparatus for receiving emergency warning messages, said apparatus comprising:
a power supply operable in at least a full power mode and a standby mode, said power supply providing power to a television receiver;
a tuner adapted to receive a plurality of television broadcasts, said tuner being operable with said power supply in said standby mode;
a decoder receiving a broadcast signal from said tuner, said decoder monitoring for an emergency warning message contained in said broadcast signal, said decoder causing said power supply to switch to said full power mode upon receipt of said emergency warning message thereby causing said television receiver to be fully operable, said decoder being operable with said power supply in said standby mode; and
a means for presenting said emergency warning message.

7. The apparatus of claim 6 further including a processor executing a process including determining if said emergency warning message is applicable to a location of said apparatus.

8. The apparatus of claim 6 further including a processor executing a process including switching said power supply to full power mode from said standby mode.

9. The apparatus of claim 6 further including a timer responsive to receipt of said emergency warning message, said timer returning said power supply to said standby mode after a selected time.

10. The apparatus of claim 6 further including a volume control responsive to a volume control signal generated by said decoder upon receipt of said emergency warning message whereby said volume control is set to a selected volume level upon receipt of said volume control signal

11. An apparatus for detecting emergency warning messages, said apparatus comprising:
a decoder receiving a broadcast signal containing an emergency warning message, said decoder detecting said emergency warning message; and
a processor receiving from said decoder a set of data upon receipt of said emergency warning message by said decoder, said processor executing a process including
activating a television receiver to present said emergency warning message wherein said step of activating includes switching a power supply to full power mode from a standby mode.

12. The apparatus of claim 11 wherein said processor executes a process further including determining if said emergency warning message is applicable to a location of said apparatus.

13. The apparatus of claim 11 wherein said decoder extracts a set of data from a header sent as part of said emergency warning message.

14. The apparatus of claim 11 wherein said decoder extracts a set of data from a header sent as part of said emergency warning message, said set of data including a location code.

15. An apparatus for receiving emergency warning messages, said apparatus comprising:
a means for receiving a plurality of television broadcasts,
a means for decoding said plurality of television broadcasts to determine whether an emergency warning message is present;
a means for activating a message presenting system after detecting said emergency warning message; and
a means for deactivating said message presenting system.
